(19) United States
(12) Patent Application Publication
(10) Pub. No.: US 2005/0171867 A1
(43) Pub. Date: Aug. 4, 2005

(54) Vehicle accessory quoting system and method

(76) Inventors: Donald Doonan, Medicine Hat (CA); Brone Miller, Medicine Hat (CA)

Correspondence Address: BENNETT JONES LLP;4500 Bankers Hall East, 855 - 2nd Street SW, Calgary, AB, T2P 4K7, CA

(21) Appl. No.: 11/024,933

(22) Filed: Dec. 30, 2004

Related U.S. Application Data
(60) Provisional application No. 60/481,909, filed on Jan. 16, 2004.

(51) Int. Cl. G06F 17/60

(52) U.S. Cl. 705/27

(57) ABSTRACT

A system for quoting vehicle accessories includes an internet accessible computer database having information regarding vehicle accessories including a suggested price; and application software including a routine permitting a user to generate a user profile to select accessories of interest from the database and enter a price adjustment for the accessories of interest to create a filtered database based on the information regarding vehicle accessories and filtered to include information on the accessories which is user specific. A method for quoting an installed price for a vehicle accessory, including: providing an internet accessible computer database including information regarding a plurality of accessories, including an accessory identifier and price for each of the plurality of accessories; providing a user profile for a user, the user profile including a selection of accessories of interest, and an installation cost adjustment and being populated with the price for each of the plurality of accessories from the computer database; and querying the user profile to output an installed price for an accessory of interest based on the installation cost adjustment and the price for each of the plurality of accessories from the computer database. The system and method can facilitate the sale of vehicle accessories, for dealerships, mechanics, vehicle parts installers, etc. When used for insurance settlement applications, the database can facilitate the acquisition of information relating to the installed costs of accessories when assessing part replacement in an insurance claim.

### TECHNICAL FIELD

This invention relates to a product quoting system and method and, more particularly, to vehicle accessory price quoting system and method.

### BACKGROUND OF THE INVENTION

It is well known that computer systems, such as computer databases available via the Internet, have facilitated research and the handling of information. Computer systems have been used to obtain information on, and to purchase, goods and service. However, even now after most automobile dealerships and manufacturers have embraced the computer systems and the Internet, the traditional process for purchasing automotive vehicle accessories continues to prevail. That process is usually complicated and very time consuming. In many instances, the customer may experience difficulty in receiving a quote to accessorize the new vehicle they have just purchased and many customers are uncomfortable purchasing accessories for the vehicle they've selected without first knowing the total price. Many vehicle customers may also wish to see what the accessory looks like on the vehicle prior to purchase and installation. The traditional method of selling vehicle accessories may not allow for this.

Insurance companies can experience many similar problems relating to the pricing of vehicle accessories to those experienced by customers. In particular, there is often no easy way of determining the installed price for an accessory when preparing or approving a quote for vehicle repair or replacement.

### SUMMARY OF THE INVENTION

Thus, it would be desirable to provide a quoting system that offers users access to the installed price of accessories installed within a dealership or repair shop. Accessories may include items such as mirrors, tires, remote start systems, daytime running lights, etc.

In one aspect of the present, invention, there is provided a vehicle accessory quoting system, comprising: an internet accessible computer database having information regarding vehicle accessories including a suggested price; and application software including a routine permitting selection of accessories of interest from the database and enter a price adjustment for the accessories of interest to create a filtered database based on the information regarding vehicle accessories and filtered to include information on the accessories which is user specific.

In another aspect of the present invention, there is provided a vehicle accessory quoting system, comprising: an internet accessible computer database including information regarding a plurality of accessories, including an accessory identifier and price for each of the plurality of accessories; a user profile for a user, the user profile including a selection of accessories of interest, and an installation cost adjustment; and application software for (i) accessing the internet accessible computer database to populate the user profile with a price for each of the accessories of interest and (ii) applying the installation cost adjustment to the price for each of the accessories of interest in response to a query from the user to generate an installed price quote for an accessory of interest. It is to be understood that the user profile may, in some embodiments, also function as the application software, being able to perform some of the same functions of the application software, such as access the internet accessible computer database and generate information on accessories in response to user queries.

The internet accessible computer database may further include a description and/or a visual depiction (i.e. drawing, photo, etc.) of each accessory. In one embodiment, the database includes an “as-installed” visual depiction of the accessory on a vehicle of interest. The database may include information regarding accessories for one or a plurality of manufacturers. The accessory identifier may, for example, be a product number, product name, etc.

The user may be, for example, a dealership, a mechanic shop, an insurance company, an insurance estimator, a body shop, etc.

The user profile may take various forms, depending on the requirements of the user, the system complexity, etc. In one embodiment, for example, the installation cost adjustment may be a cost established and entered for each accessory of interest. Alternately, the installation cost adjustment may be a calculation based on labor charges for the user and the number of hours for installation for each accessory of interest. In yet another alternative, accessories of interest may be grouped by type in the profile and a labor cost adjustment can be applied similarly for each accessory of that type rather than individually.

In another embodiment, the user profile may allow for the selection of an internal installation cost adjustment and a retail installation cost adjustment.

The user profile may also include other features such as (i) an accessory price adjustment, which contains a price adjustment, an increase or reduction, to be applied to the accessory price populated into the profile from the database; (ii) a financing calculation, etc.

The application software is selected to perform the functions to at least (i) access the internet accessible computer database to populate the user profile with a price for each of the accessories of interest and (ii) apply the installation cost adjustment to the price for each of the accessories of interest in response to a query from the user to generate an installed price quote for an accessory of interest. The function of accessing the internet accessible computer database can employ either continuous or periodic push or pull technology.

In some embodiments, the application software may be required to perform other functions, for example, to address some of the other user profile features noted hereinabove.

The application software may be selected to identify access levels within the user. For example, the application software may be selected to identify an administrator level access and a retail purchase level access. In some embodiments, other levels of access may also be desirable such as a manager level access. Each of the access levels may have an associated permissible query/response scope through the application software. Alternately or in addition, each of the access levels may have permitted control over the user profile including, for example, no control, read-only control, modification control, etc.

In accordance with another broad aspect of the present invention, there is provided a method for quoting an installed price for a vehicle accessory, the method including: providing an internet accessible computer database including information regarding a plurality of accessories, including an accessory identifier and price for each of the plurality of accessories; providing an application software for use by a user, the application software including a selection of accessories of interest to the user, and an installation cost adjustment for the user and being populated with the price for each of the plurality of accessories from the computer database; and querying the application software to output an installed price for an accessory of interest based on the installation cost adjustment and the price for each of the plurality of accessories from the computer database.

In one embodiment of the method for quoting, the installed price can be matched with a quote for a complete vehicle and/or the installed price information can be used to output various financing scenarios based on a vehicle with or without the accessory. In another embodiment, the method can include displaying visual depictions of an accessory or of an accessory as-installed on a vehicle of interest, as populated from the computer database, so that the prospective purchaser can view the accessory without requiring reference to separate paper manuals.

The method may further include providing a user profile to include a selection of accessories of interest. In one embodiment, the method may include at least periodically repopulating accessory information to the user profile from the computer database information. The user profile can be installed on a user's personal computer, local area network or can be housed on a web server. Thus, the repopulating method can vary. In one embodiment, the computer database and the user profile are both supported on a web server wherein any updates to the database information will automatically populate the user profile. Alternately, the user profile can be programmed to require maintenance upgrades for continued functioning such that the user must connect to a web server to obtain updates including repopulation of information from time to time.

The method may further include creating a user profile for the user, including any of various options for display, price adjustments, user access levels, etc.

The system and method can facilitate the sale of vehicle accessories, for dealerships, mechanics, vehicle parts installers, etc. When used for insurance settlement applications, the database can facilitate the acquisition of information relating to the installed costs of accessories when assessing part replacement in an insurance claim.

### BRIEF DESCRIPTION OF THE DRAWINGS

FIG. 1 is a schematic diagram of a system according to the present invention.

FIG. 2 is a schematic diagram of a method according to the present invention for use with the system of FIG. 1.

FIG. 3 is a schematic diagram of a system according to the present invention.

FIG. 4 is a schematic diagram of a user client set up useful in the present invention.

FIG. 5 is a schematic diagram of a website including a quoting system and a method of using the website to set up a user profile based on information contained in the website.

FIG. 6 is a chart showing a functionality useful for setting up a user-specific profile useful in the present invention.

FIG. 7 is a schematic diagram of a system according to the present invention.

FIG. 8 is a depiction of a web page employing functionality useful for obtaining a quote for accessories according to one aspect of the present invention.

FIG. 9 is a depiction of a output web page generated according to one aspect of the present invention to display available accessories and pricing information for a vehicle of interest.

### DETAILED DESCRIPTION OF VARIOUS EMBODIMENTS

A user-specific accessory price quoting system and method are described herein. The following describes the use of a computer database accessible through the internet to provide users such as automobile, truck, motorcycle and/or sports vehicle dealerships, insurance companies, insurance adjusters and/or vehicle repair shops with their own installed price for vehicle accessories. Users will appreciate the ease of accurately quoting “installed” prices for vehicle accessories.

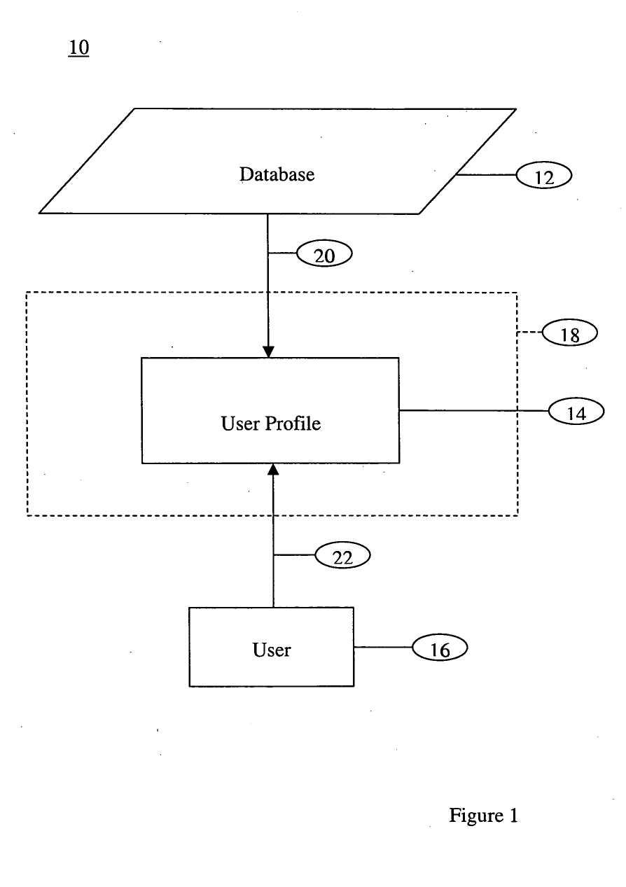

Referring to FIG. 1, a vehicle accessory quoting system 10 is shown. System 10 includes an internet accessible computer database 12 including information regarding a plurality of vehicle accessories, including an accessory identifier and price for each of the plurality of accessories; application software 18 that includes a user profile 14 for a user 16, and wherein the user profile includes a selection of accessories of interest, and an installation cost adjustment for the accessories of interest, and wherein the application software can (i) access 20 internet accessible computer database 12 to populate user profile 14 with a price for each of the accessories of interest and (ii) apply the installation cost adjustment to the price for each of the accessories of interest in response to a query 22 from the user to generate an installed price quote for an accessory of interest.

The application software may contain a number of optional routines for additional functions.

In the illustrated embodiment, user profile 14 and application software 18 may be installed on a user's personal computer or local area network, while database 12 is supported on a web server. When accessing 20, the application software may be selected to periodically connect with database 12 on the web server and to pull the necessary information to populate user profile 14.

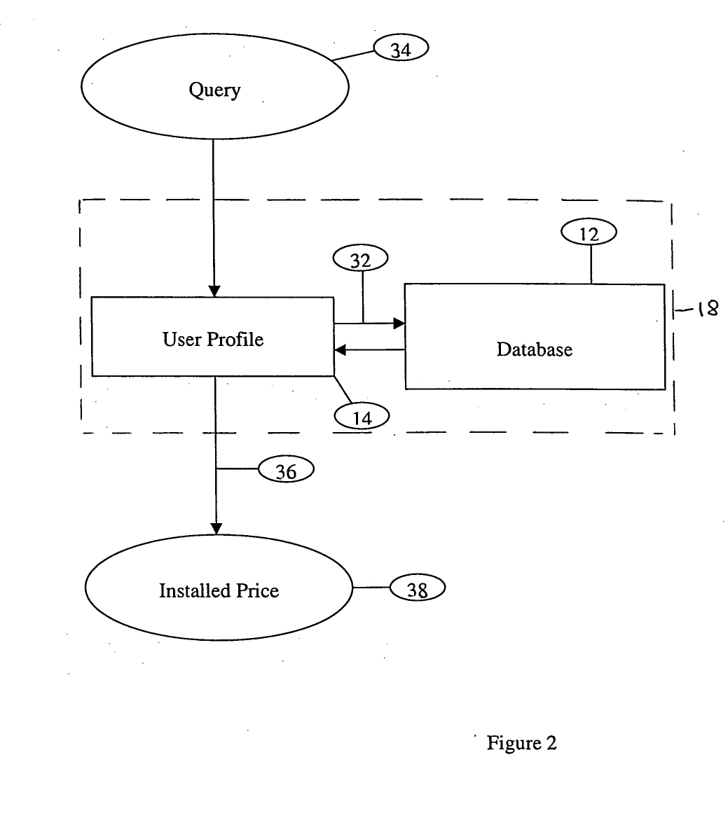

Referring to FIG. 2, there is shown a schematic diagram of a method 30 for quoting an installed price for a vehicle accessory. In the method there is provided an internet accessible computer database 12 including information regarding a plurality of accessories. The information includes an accessory identifier and a price for each of the plurality of accessories. There is also provided application software 18, which may include a user profile 14 for a user. The user profile including a selection of accessories of interest, and an installation cost adjustment and being populated 32 with the price for each of the accessories of interest from computer database 12. The method includes querying 34 the user profile through the application software to output 36 an installed price 38 for an accessory of interest based on the installation cost adjustment and the price from the computer database.

The most common users are likely to be automotive vehicle dealerships. As such, the following description proceeds with reference to dealership applications. However, it is to be understood that the system and the method may also be employed by other users such as a mechanic shop, an insurance company, an insurance estimator, a body shop, etc., which may be employed as a link to a dealership's web page.

The present method and system may provide a dealership-specific, filtered, installed accessory price list that will be accessible to any authorized computer or individual in the dealership. The system including an internet accessible database ensures that current accessory part pricing is regularly provided to the system at the dealership. This system provides dealership employees the ability to accurately quote their own installed prices without having to phone the parts department, service department and body shop for prices and, therefore, provide more accurate complete quotes to customers when they purchase their vehicle, even if the other departments are busy or closed. The system and method also free up time for parts, service and body shop employees since they are relieved from looking up and quoting prices for accessories. In one embodiment, the system can also be accessed through a website via a kiosk or other authorized computer in the dealership showroom to provide customers the ability to browse available accessories for their vehicle. The internet database can allow an authorized salesperson, employee or customer to view accessories and installed prices 24 hours a day/7 days a week without having to contact a salesperson or another department for a quote.

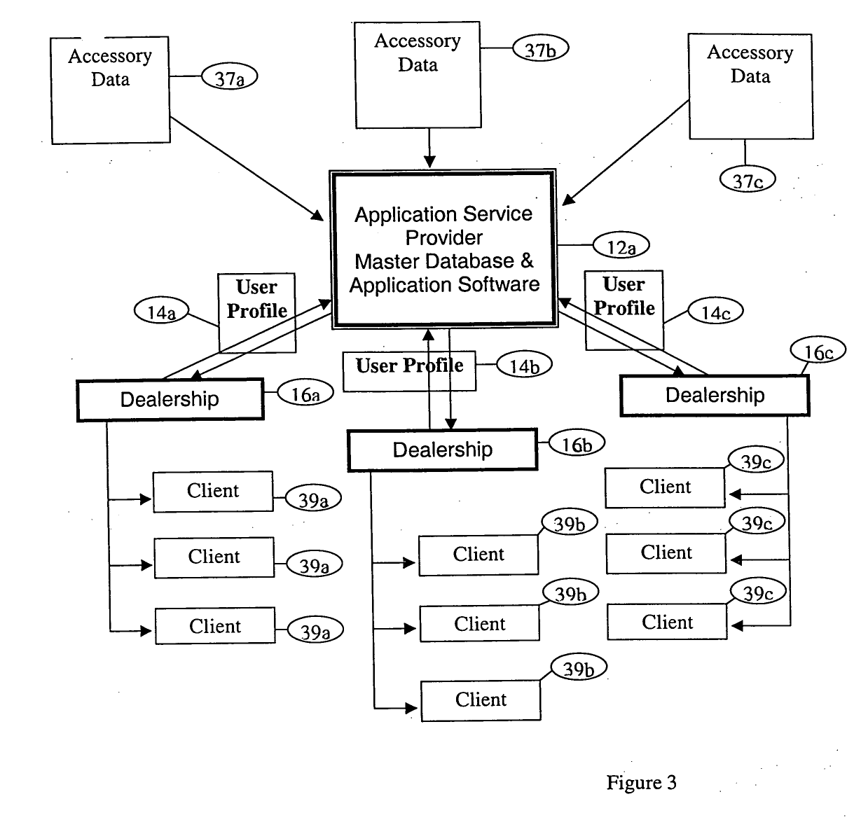

In one embodiment, as schematically shown in FIG. 3, the system can include application software and a master database 12a, which contains vehicle accessory data from a number of sources 37a, 37b, 37c, such as accessory manufacturers, vehicle manufacturers and/or accessory suppliers. The application software and the master database are accessed by a number of separate dealerships 16a, 16b, 16c which all have their own user profiles 14a, 14b, 14c through which filtered, dealership-specific information for accessory installation price quoting is available to their system clients 39a, 39b, 39c. While each dealership 16a, 16b, 16c accesses the same database information, each individual dealership has control over their own user profile, which permits them to set their own options with regard to price adjustments (i.e. final part pricing, labor charges, etc.) and system display and configuration. Controls may be set up through the application software in 12a to ensure confidentiality of user profiles between dealerships. In addition, it may be desirable to set up other controls through the application software, for example, to limit access by selected dealerships 16a, 16b to accessory data of selected accessory data sources 37a. This may be useful where some sources of accessory data wish to reveal their accessory data to only certain dealerships authorized by them.

System clients, including employees, managers, and customers, may generate installed vehicle accessory prices customized to their own dealership, by using the user profile via any dealership computer terminal which includes filtered database information. The web-based database facilitates the quote process by possibly being available 24/7 and being regularly updated and the user profile manages the dealership information with pricing based on the database. The system and method may be further developed in some embodiments.

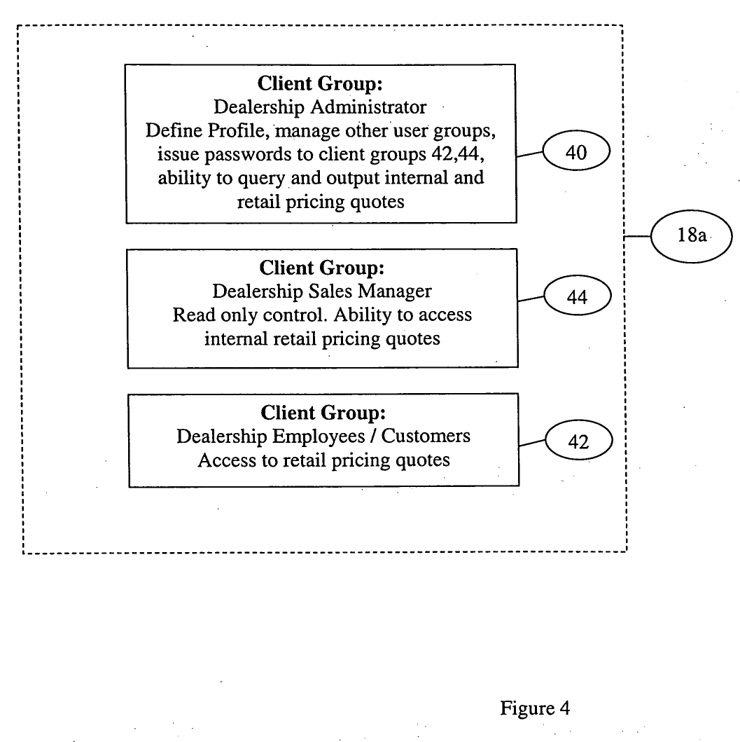

For example, the dealership, as user, may wish to identify access levels for query and response scope. For example, with reference to FIG. 4 the application software 18a may be selected to identify an administrator-level client group 40 and a retail purchase-level client group 42, each with their own access rights. In some embodiments, it may be desirable to provide further user levels of access such as a manager-level client group 44. Each of the client groups may have an associated permissible query/response scope through the application software. For example, it may be desirable that the system output both internal and retail quotes. Internal quotes may be those, for example, for an employee purchase or for refurbishing a used vehicle wherein part pricing and labor costs may be reduced relative to those for retail situations. Alternately or in addition, each of the client levels may have permitted control over the user profile including, for example, no control, read-only control, modification control, etc.

In one embodiment, for example, a client from administrator-level group 40 may have the ability to generate internal and retail installed accessory quotes. This user may also have one or more modification control rights over the user profile such as the ability to define or modify the user profile template, to manage other user groups, to issue client passwords, etc. A client within the manager-level group 44 may have read-only control over the user profile, for example to view profile parameters, and may be able to access both internal and retail price quotes. A client with retail purchase-level 42 rights may be for example dealership employees through their desk terminals or customers accessing the system, for example, via a kiosk in the sales room. These clients may generally have access rights to generate retail price quotes, but have no rights to view or modify the user profile template.

To provide a system and/or a method, such as depicted in FIGS. 1, 2 and 3, a master database can be provided, as by creation and maintenance thereof by a service provider, and can be set up in an internet accessible manner such as on a website. The user profile can be provided for example by provision of a standard template, by modification of a standard template or by creation thereof. The system can be driven by application software.

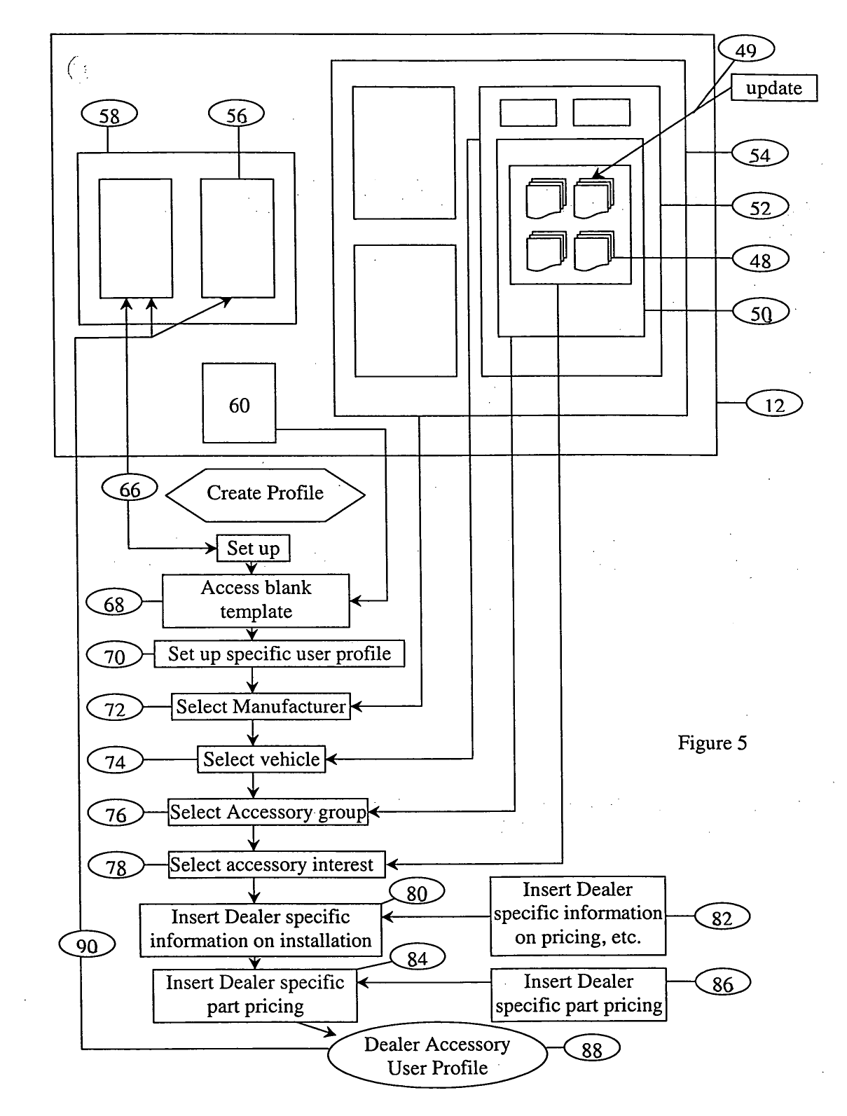

As schematically illustrated in FIG. 5 for one embodiment of this invention, master database 12 can be created by a service provider to contain information 48 including, for example, accessory identifiers (i.e. part numbers, product name, etc.), descriptions, accessory pictures and accessory part suggested retail and cost prices. Information 48 in the database may also include vehicle information to which the accessory is associated, images and as-installed images including relevant depictions of the vehicle with the accessory installed thereon. Periodically, the service provider can update 49 information 48 in the database to reflect changes, additions and deletions in vehicle appearance and availability, accessory pricing, appearance and availability, etc.

The information of the database may, for ease of use and management, be categorized according to accessory type 50 (cargo, wheels, interior, etc.) and/or vehicle type 52 (cars, motorcycles, trucks, SUVs, etc.) and/or manufacturer 54. Searching terms and capabilities may also be included to facilitate handling of the information.

The system can further be created to include information relating to user 56 and functionalities relating to user profile 58 administration, such as a user profile blank template 60, user information and billing features. In one embodiment, information relating to user 56 and functionalities relating to user profile 58 administration can be contained in application software that provides access to master database 12. However, it will be appreciated that this type of information can also be contained in other components of the system such as in a web server, in the master database, etc.

In preparing the user profile, the dealership can select from the database vehicles and accessories of interest and can input dealer specific pricing parameters. This can provide an accurate, dealer-specific, accessory price quoting tool. If desired, the dealership may also wish create the user profile with functionality permitting electronic display of the accessory alone or as installed such that a client using the system has the ability to view the accessory of interest along with the quote.

In one embodiment, the user profile can be created using the following steps. First, the dealership can select the vehicles of interest, whereby the make, manufacturer and year of the vehicles may be specified. Second, hourly labor rates for installation for different departments of the dealership can be entered. Third, accessories of interest to the dealership can be selected by vehicle. Fourth, the dealership can then enter price adjustment formulas whereby labor charges or accessory pricing can be modified. Fifth, users having different access privileges can be added to the user profile. It is to be understood that these steps can be reordered or modified in any manner, if desired.

When a dealership wishes to begin using the system, a dealership administrator client creates the dealership user profile while connected to the master database on the website. First, the service provider and administrator must set up 66 the dealership information through the user administration 56 function so that the dealership is recognized as a user and is permitted access.

The dealership administrator may then access 68 the blank user profile template and begin to set up the specific user profile 70 for that dealership, including for example customizing the display appearance, identifying clients (computers and/or individuals) with access, assigning client passwords, etc. The administrator can from the master database select 72 the manufacturer(s) 54, select 74 vehicles 52 of interest, select 76 accessory groups 50 of interest and select 78 accessories of interest to be accessible through the dealership's user profile. The administrator can also input 80 the dealership specific information 82 for each accessory or accessory group including the labor hours for installation, the dealership hourly labor rates for internal and retail, if different, and the shop supplies as a percentage of each of the individual labor charges.

The administrator can choose 84 the prices 86 they want to apply to the accessories in the user profile based on retail price from the master database plus or minus a percentage or cost price from the master database plus a percentage for both retail and internal sales. This is done by entering the desired price adjustment formula that is applied to a price read from master database 12. Alternately, the administrator can use a formula that overrides any of the individual accessory prices with a different set price. The formula can take many different forms, which include the use of a price override electronic page available through application software 18.

Alternately or in addition, a dealership can also add its own dealership-specific accessories and visual depictions to its user profile.

The dealer-specific accessory user profile 88 can then be saved 90 and used for accessory price quoting by the dealership. The user profile functions to provide a filtered, dealership-specific source of accessories available through the dealership, accessory information and pricing, as based on the information 48, 50, 52, 54 contained in database 12. No changes, for example, pricing changes in the user profiles will change the information contained in the master database.

When the master database is updated 49 with new prices the price change information will be repopulated into the dealership system and applied by using formulas and the dealership template data. Accessory prices that had price adjustment formula indicating a price override are not updated on price changes but a notification may be provided to the dealership administrator concerning the price change.

The steps in the above-noted user profile creation process can be modified and/or reordered if desired.

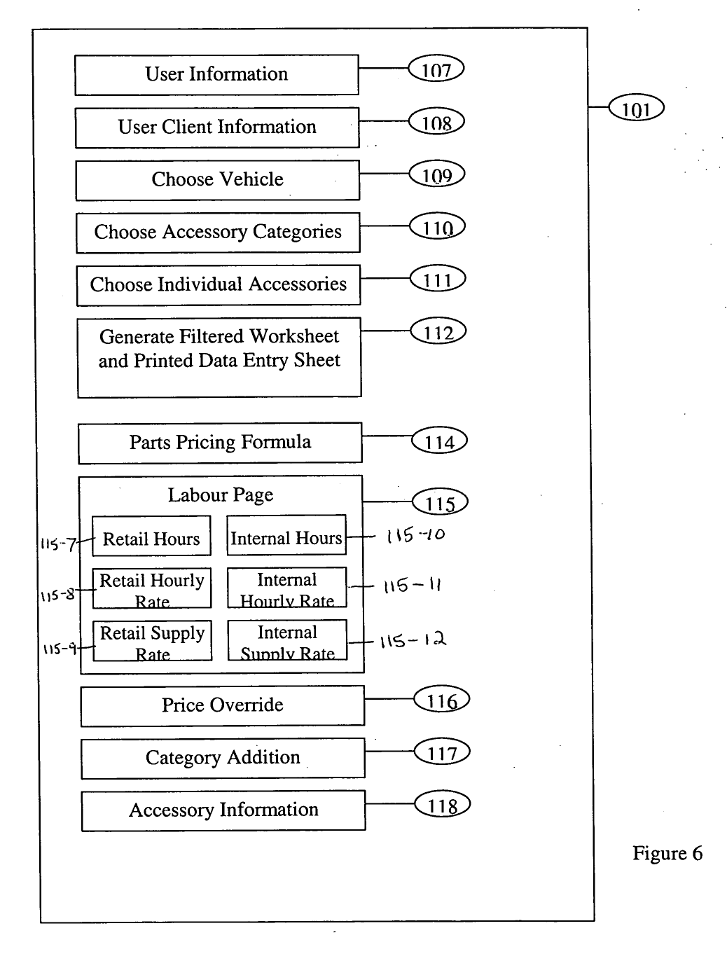

In one embodiment, the website dealer template creation process 101 can include primary sequential functions, for example, via website generated electronic pages. As shown in FIG. 6, the database is accessed by the dealership administrator by a unique password to select a dealer specific filtered list of items, as follows:

107 electronic page to enter user information for example the dealership logo and contact information, which will appear on generated quotes and on the system display

108 electronic page to enter user client ids and passwords

109 electronic page to choose vehicle models from those available to them in the database

110 electronic page to choose accessory categories

111 electronic page to choose individual accessories of interest to the dealership

112 electronic page on which a filtered worksheet of accessories chosen by vehicle is created, then printed and used to manually enter the amount of labor hours required for the installation of different accessories, and later used to enter these amounts into the dealer-specific accessory user profile

114 parts pricing formula electronic page

115 retail and internal labor electronic page

116 individual part override electronic page

117 category addition electronic page, which may include dealership-specific promotional accessories such as clothing, etc.

118 accessory addition electronic page, which may provide pricing of promotional accessories, etc.

Of course, alternately or in addition, electronic pages that can be used to determine financing options or to customize the format of generated data may also be present in the website dealer template creation process.

Entries in the retail and internal labor function 115 can, if desired, be made a number of steps, such as:

115-7 Enter the retail and internal mechanical—body shop—paint labor installation hours for each accessory or accessory category, which may be entered using the data entry page worksheet

115-8 Enter the retail mechanical—body shop—paint labor hourly rates,

115-9 Enter the retail mechanical—body shop—paint labor shop supply rates,

115-10 Enter the internal mechanical—body shop—paint labor installation hours,

115-11 Enter the internal mechanical—body shop—paint labor hourly rates,

115-12 Enter the internal mechanical—body shop—paint labor shop supply rates,

The dealership administrator has access to and selected data entry/modification rights in the above-noted functions. The template creation process can be exited directly from any one of the functions. The software application supporting the creation of the profile can include tabs and or links to facilitate the process. A password supplied by the web host will provide for administration access. Internal access passwords for internal and retail web page read-only access will be set up by the administrator.

The above-noted process creates a user profile for the dealership including a filtered database of accessories and their dealership-specific pricing.

The user profile of the system can be supported on the user's computer terminal or can be supported on the service provider's website. Where the user profile is supported on the dealership's computer terminal(s), a client can access the system via a routing address and will be required to work through a log in page including a client id and password. The user will be required to connect to, or accept information from, the internet accessible database at least periodically to repopulate the user profile information from the database. If desired, the application software can be configured to require the use to regularly (once a day, once a week, etc.) connect to the website in order to retain functionality. This configuration ensures that the user continues to pay for the service and can rely on the generation of up to date output from the system. Where a user's profile is supported directly on the service provider website, a client can access the system via a specific URL, which brings up a log-in page requesting the dealership id and password. The client may then be required to work through a second log in requesting a client id and password.

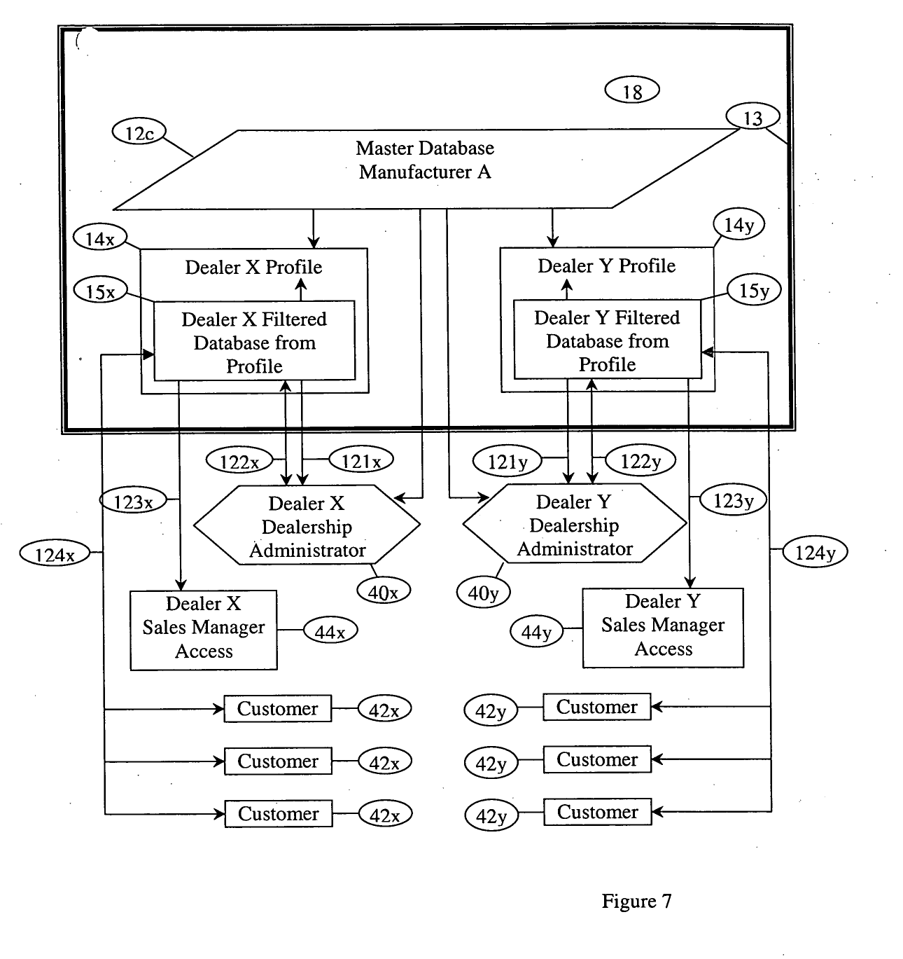

Referring to FIG. 7, a schematic illustration of a system is shown wherein the master database 12c for a particular manufacturer is supported on a service provider website 13 along with application software 18. Two dealerships, Dealer X and Dealer Y, have created user profiles 14x, 14y, which have been saved on website 13. The user profiles provide a filtered database 15x, 15y for each dealership to provide filtered information from database 12c and price adjustments which are specific to the dealership. It is noted that user profile 14x and its filtered database 15x are accessible to Dealer X personnel, but not to any individuals from Dealer Y, in spite of the fact that they both use accessory information from database 12c.

The dealership personnel can connect to the quoting system on website 13 through any computer terminal offering internet access. As noted hereinabove the dealership personnel may be divided into two or three different client groups, all having access to the quoting system through the website but with different abilities to view internal pricing and to access to the user profile setup pages. These client groups can include (i) the administrator 40x, having full access and control 121x of the dealership template 14x and ability to access the filtered database 15x to obtain 122x dealership-specific installed price quotes based on both retail and internal pricing, (ii) the sales manager 44x, having access 123x to retail and internal installed prices and possibly access to the user profile template on a read only basis and (iii) the retail purchase-level access clients 42x, including general employees, sales personnel and customers through on-site terminals. Clients 42x can connect 124x to the website to browse the filtered database 15x and obtain retail installed-price quotes and accessory information (descriptions, images, etc.).

Likewise, Dealer Y can include an administrator client 40y, a manager client 44y and retail purchase level clients 42y, all having access to the website for various information. Of course, while particular numbers of such clients are shown in this Figure, it is to be understood that any particular user may select to have more or fewer such clients in each group or more or fewer client groups. For example, a dealership may select to have a number of clients with manager type access.

The website is designed to allow system clients, such as dealership employees and customers, to browse and research information about the available vehicle accessories, view the items, and receive an installed price through the system. There may be a common navigational scheme used throughout the site to facilitate the browsing processes. The navigation buttons may be linked to sections of pages within the site. When a button is selected, the user/customer may be brought to the starting page of that section and the button may remain highlighted. Alternately or in addition, scroll or pull-down menus may be present allowing clients to scroll through the plurality of available accessories and select the ones of interest.

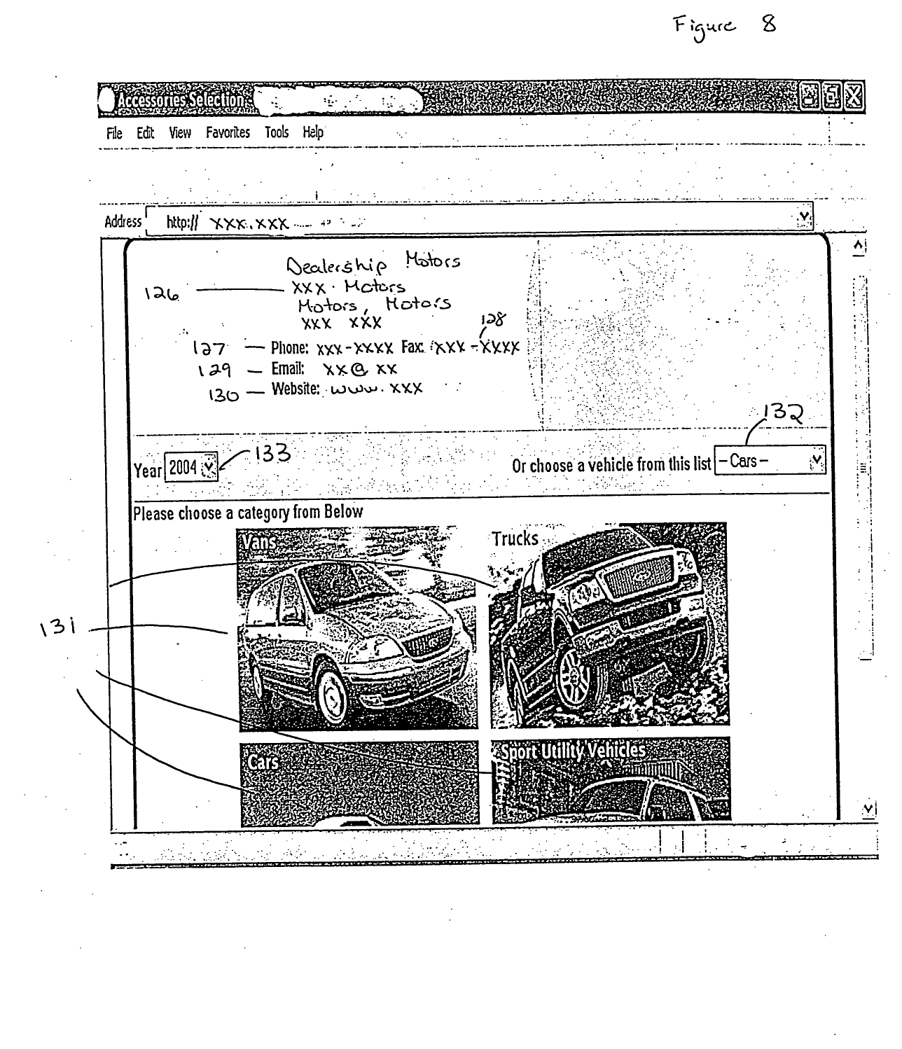

Referring to FIG. 8, an example of a quote request page is shown, as may appear when a client first enters the system to obtain a quote. In this example, quote request page 125 includes a plurality of specific dealership information, such as dealership name, logo and address 126, phone number 127, fax number 128, email address 129, and hyperlinked website address 130. To request a quote, a client is able to first select a vehicle category, which can include, for example, vans, trucks, cars and sport utility vehicles. The selection can either be made by clicking on visual depictions 131 of the vehicle category of interest, or the specific make and year of the vehicle of interest can be selected using pull-down menus 132 and 133, respectively.

Visually, both the retail purchase and the sales manager versions of the system can have the similar input and output page display with the only difference being the sales manager page showing internal installed prices.

During the shopping process, the customer is able to choose the vehicle and then the accessory category. They then choose one of the accessories within that category to view both the part and the installed price. They may then choose that accessory to add to a quote list. The next step shows a page that gives a total of all items chosen with the part numbers and prices.

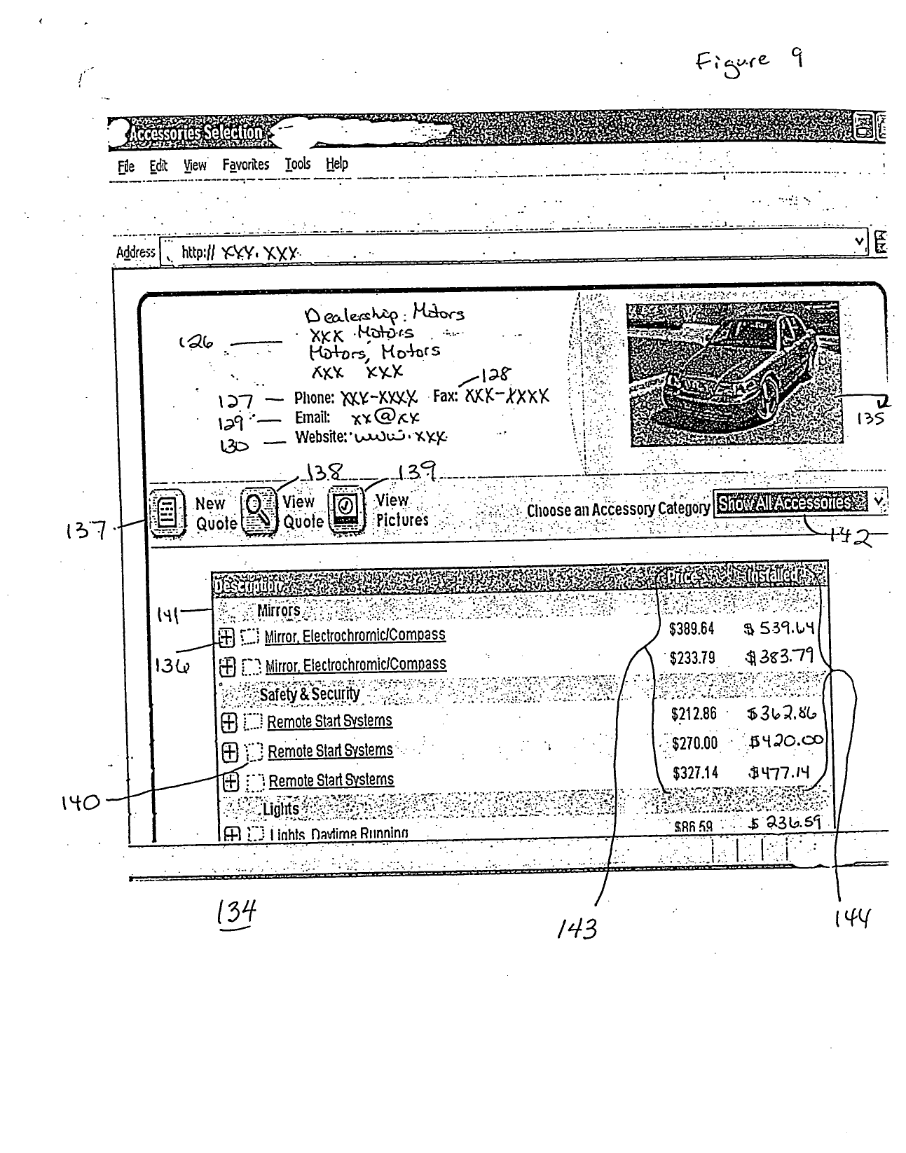

Shopping customers have the capability to locate a category by search. Search results provide the customer with a list of all accessories within that category that the dealership has chosen from the master list and any parts he has added to that list. The customer can then select any accessory within that category and from that the system will generate an output displaying the accessory information, an accessory image and/or an accessory as installed image and an installed price for each accessory. An example of this process is illustrated in FIG. 9. Electronic page 134 contains a plurality of dealership information, such as dealership name, logo and address 126, phone number 127, fax number 128, email address 129 and hyperlinked dealership website address 130. A visual depiction 135 of the vehicle of interest can also be shown. From this page, the client can select from several different options that can take the form of navigation buttons, hyperlinks, etc., which include, for example, add accessories to quote 136, New Quote 137, View Quote 138, and View Pictures 139. When the New Quote button or hyperlink is selected, a client can be taken back to the initial electronic page where the vehicle type can be selected and can begin the process again, if desired. When the View Quote button or hyperlink is selected, a quote for any selected accessories is created and can appear on the same electronic page, a different electronic page and/or in the form of a pop-up window. When the View Pictures button or hyperlink is selected, a small thumbnail image 140 of each accessory can appear by its hyperlinked name or description in description box 141. Of course, it will be understood that the location of the thumbnail images can be varied, if desired. The description box can display a list of all accessories, which can be in hyperlink format. An accessory can be selected via hyperlink in the description box to view its description and/or visual depiction. The description and visual depiction, which can be of the accessory and/or of the accessory as installed, can appear in the same electronic page, a different electronic page and/or in a pop-up window. The visual depiction obtained can be identical or different to that obtained in the small thumbnail image. Description box 141 can also show both the accessory price 143 and installed accessory price 144 of each selected accessory, which may be the same if the accessory is purchased uninstalled. If desired, only a selected one of the installed price or the uninstalled price may be shown. Pull-down menu 142, which can include all accessory categories available through the dealership's user profile, can also be available to allow the client to select accessories of interest. To select an accessory, a client can use the add accessories to quote 136 button or hyperlink present in the description box by the accessory of interest, which can result in the addition of the selected accessory to the quote. The add accessories to quote button or hyperlink can be located beside each hyperlinked accessory in the description box. However, it is to be understood that its location can be varied, if desired. Additional accessories may then be selected and added to the quote in the same way, if desired.

Of course, if desired, the output page can include more or less information based on dealership requirements.

As such, the system can track the following functions entered by the client:

1. Select vehicle,

2. Select category,

3. Select accessory,

4. Generate preview accessory information, image(s) and installed price,

5. Select accessory to add to accessory list,

6. Select print of summary of accessories details and installed prices.

In one embodiment, the system can also correlate the price of a vehicle with installed accessories with the base vehicle pricing information to give the client an overall price. Vehicle pricing information can be contained in several different components of the system, such as the master database or the user profile

In another embodiment, the system can also include an option to show clients the effects of adding accessories of interest to financing charges, etc. This option could be added in several locations in the system, including the electronic pages used by clients to select accessories of interest.

If desired, links may be included to provide access to the dealerships' websites and manufacturers' websites. If a link is selected, a pop-up window may contain the new site with the subject site remaining open. In addition, a link may be provided to send an e-mail to the web designers for concerns or comments.

The system provides customers with the capability to customize their own vehicle, viewing and selecting accessories, while checking the price of each addition. After choosing their vehicle accessories, a customer can print the quote which will give part numbers, descriptions and an installed price total for all accessories chosen.

Thus, an vehicle accessory shopping tool is provided that includes the ability to configure a database to provide an online access to a user-specific price quoting system. In other words, the clients within the dealership are empowered to the extent that even when the other departments are closed, the salesperson can quote and close accessory sales with the customer. The system allows the customer with or without the help of a salesman to browse available accessories, select an accessory of interest and to view the accessory of interest along with an installed price for the accessory in the dealership in which the customer is shopping. The installed prices and information for a plurality of accessories can be compiled in a quote summary that can be printed for reference.

While particular embodiments of the invention have been shown and described, these embodiments should be considered illustrative rather than limiting.

1. A vehicle accessory quoting system, comprising:
an internet accessible computer database having information regarding vehicle accessories including a suggested price; and
application software including a routine permitting selection of accessories of interest from the database and enter a price adjustment for the accessories of interest to create a filtered database based on the information regarding vehicle accessories and filtered to include information on the accessories which is user specific.

2. A system according to claim 1 wherein the application software is accessed by the customer via a website and wherein the user profile is generated by accessing the database and selecting the accessories of interest to be included in the user profile and submitting data regarding the user's retail and internal pricing information for the accessories of interest.

3. A system according to claim 1 wherein the database is supplied with information by an entity selected from the group consisting of an accessory manufacturer, a vehicle manufacturer or an accessory supplier.

4. A system according to claim 1 wherein the user is selected from the group consisting of an automobile dealership, an insurance company, a repair shop or an insurance estimator.

5. A system according to claim 1 wherein the application software includes a user profile and the user profile includes information about the user.

6. A vehicle accessory quoting system, comprising: an internet accessible computer database including information regarding a plurality of accessories, including an accessory identifier and a suggested price for each of the plurality of accessories; and application software including a user profile for a user, wherein the user profile includes a selection of accessories of interest, and an installation cost adjustment, the application software being capable of (i) accessing the internet accessible computer database to populate the user profile with a price for each of the accessories of interest and (ii) applying the installation cost adjustment to the price for each of the accessories of interest in response to a query from the user to generate an installed price quote for an accessory of interest.

7. The system of claim 6 wherein the internet accessible computer database further includes a description and/or an image (i.e. drawing, photo, etc.) of each accessory.

8. The system of claim 6 wherein the internet accessible computer database further includes an as-installed image of the accessory on a vehicle of interest.

9. The system of claim 6 wherein the installation cost adjustment is a cost established and entered for each accessory of interest.

10. The system of claim 6 wherein the installation cost adjustment is a calculation based on the suggested price.

11. The system of claim 6 wherein the accessories of interest are grouped into categories in the user profile and a labor cost adjustment is applied similarly for each accessory of that type rather than individually.

12. The system of claim 6 wherein the user profile allows for the selection of an internal installation cost adjustment and a retail installation cost adjustment.

13. The system of claim 6 wherein the user profile includes an accessory price adjustment, which contains a price override, an increase or reduction, to be applied to the accessory price populated into the profile from the database.

14. The system of claim 6 wherein function of accessing the internet accessible computer database employs either continuous or periodic push or pull technology.

15. The system of claim 6 wherein the application software is selected to identify access levels within the user.

16. A method for quoting an installed price for a vehicle accessory, the method including: providing an internet accessible computer database including information regarding a plurality of accessories, including an accessory identifier and price for each of the plurality of accessories; providing application software for use by a user, the application software including a selection of accessories of interest to the user, and an installation cost adjustment for the user and being populated with the price for each of the plurality of accessories from the computer database; and querying the application software to output an installed price for an accessory of interest based on the installation cost adjustment and the price for each of the plurality of accessories from the computer database.

17. The method for quoting of claim 16 further comprising displaying an image of the accessory of interest.

18. The method for quoting of claim 16 further comprising displaying an image of the accessory as-installed on a vehicle of interest, as populated from the computer database.

19. The method for quoting of claim 16 wherein the application software includes a user profile to contain the selection of accessories of interest to the user, and the installation cost adjustment for the user and the method further comprising at least periodically repopulating accessory information to the user profile from the computer database information.

20. The method for quoting of claim 16 wherein the application software includes a user profile to contain the selection of accessories of interest to the user, and the installation cost adjustment for the user and wherein the user profile is installed on a user system.

21. The method for quoting of claim 16 wherein the application software includes a user profile to contain the selection of accessories of interest to the user, and the installation cost adjustment for the user and wherein the user profile is maintained on a web server.

22. The method for quoting of claim 16 further comprising creating a user profile for the user.
